(19) United States
(12) Patent Application Publication
(10) Pub. No.: US 2014/0173928 A1
(43) Pub. Date: Jun. 26, 2014

(54) METHOD AND APPARATUS FOR DRYING WORKPIECES

(71) Applicant: Wolfgang Hauser, Rheda-Wiedenbruck (DE)

(72) Inventor: Wolfgang Hauser, Rheda-Wiedenbruck (DE)

(73) Assignee: VENJAKOB MASCHINENBAU GMBH & CO. KG, Rheda-Wiedenbruck (DE)

(21) Appl. No.: 14/236,391

(22) PCT Filed: Jul. 26, 2012
(86) PCT No.: PCT/EP2012/003179

§ 371 Date: Jan. 31, 2014

(30) Foreign Application Priority Data
Aug. 3, 2011 (DE) 10 2011 109 325.0

(51) Int. Cl. F26B 25/06

(52) U.S. Cl. CPC F26B 25/06
USPC 34/282; 34/201

(57) ABSTRACT

The present invention relates to a method and a device for drying, in particular for drying painted workpieces (6), which has at least two drying units (2), wherein the individual drying unit is set up to receive a number of painted workpieces, and heating means, which are set up to generate a constant temperature in the drying device (1) and in each of the drying units (2).

### FIELD OF THE INVENTION

The invention relates to a method for drying painted workpieces. The invention additionally relates to a device for drying painted workpieces.

### STATE OF THE ART

Drying devices, for drying painted workpieces, are known from the state of the art. A great multiplicity of such methods and arrangements have long been used in a number of branches of industry.

Whereas, in the field of industry, the freshly painted workpieces are hardened in drying channels by means of UV light and hot air, the craft sector uses mainly passive drying systems. The painted parts remain in the surface region until they have hardened to such an extent that they can undergo further processing. Rack trucks, for example, are known from the state of the art for storing the freshly treated parts. These trucks usually have a scissors-type connection, to enable the spacing of the supports to be adapted to the length of the workpieces. The workpieces on the rack trucks are moved for drying into drying chambers, where they remain until completely dried.

DE 10 2010 012 173 B3 describes a device for drying objects, in particular painted vehicle bodies, which comprises a drying tunnel. A painted workpiece is dried in the drying tunnel.

The drying tunnels known from the state of the art have the disadvantage that, for the painted workpieces, only a certain retention time is planned for drying. In the drying process, the painted workpieces pass through a drying tunnel in a predefined period of time. In this drying tunnel, therefore, it is not possible for the painted workpieces to be dried for differing periods of time, i.e. flexible drying times are not possible.

### OBJECT OF THE INVENTION

The object of the present invention is to rectify the disadvantages of the state of the art. Consequently, it is an object of the present invention to provide a device and a method for drying, in particular for drying painted workpieces, in which flexible drying times can be achieved. A further object of the invention is to leave the workpieces to rest in the drying device, i.e. the workpieces are not subjected to any movement, during the retention time.

### Description of the Invention

The object is achieved by the independent claims. Advantageous developments are defined in the dependent claims.

For the purpose of achieving the object, the present invention proposes a drying device, in particular for drying painted workpieces, which has at least two drying units, wherein the individual drying unit is set up to receive a number of painted workpieces, and heating means, which are set up to generate a constant temperature in the drying device and in each of the drying units.

The drying device is preferably designed as a tower or drying tower. The drying device is used for drying painted workpieces. The drying device has at least two drying units, in which the workpieces that are to be dried can be inserted and dried. The drying device may also be a flash-off device, a fume device or a tempering device.

The term drying is to be understood to include any type of cross-linking, polymerization and hardening of material, in particular the hardening of a paint by radiation. A high surface quality, and therefore a uniformly smooth flow of the paint, is to be achieved in this case.

The operation of drying the painted workpieces in the drying units of the drying device is preferably performed at 80° C. Correspondingly different temperatures for drying painted workpieces are then selected if paints require a higher or lower temperature for drying on a workpiece.

The operation of flashing-off the painted workpieces is preferably performed at room temperature in the flash-off device. During the flashing-off operation, the volatile components of a paint applied to a workpiece evaporate.

During tempering, a material is heated over a longer period of time. Such a method makes it possible, for example, to control the distribution of mechanical stresses in a component. Tempering makes it possible to selectively alter the structure and physical properties of a solid, for example the structure in the case of workpieces made of metal. It is thus possible to control the ageing process or a distress effect of a workpiece.

The painted workpieces are preferably painted metal sheets, in particular parts from automobile construction, and painted objects made of wood, plastic, porcelain or ceramic, etc.

A number of painted workpieces are preferably a multiplicity of painted workpieces that can be delivered on a workpiece carrier system, a pallet or other device, and jointly inserted in a drying unit.

The at least two drying units are dimensioned such that individual workpieces or a certain number of workpieces (for example, on a workpiece carrier system) can be received, and can be dried in the drying unit.

The drying units are preferably realized as chambers, or drying chambers, which are dimensioned accordingly for drying workpieces.

The heating means are provided as a heat source for drying the painted workpieces. Such heating means generate, for example, medium-wave or longwave infrared radiation or UV light. Drying can also be effected through the supply of hot air. The heating means are arranged centrally in the drying device, such that each drying unit can be heated to a predefined temperature. A predefined, constant temperature, at which the number of painted workpieces are to be dried, thus ensues in each of the drying units and in the drying device as a whole. In addition to the temperature, the air humidity inside the drying device, and the supply and composition of a gas, can be set.

During drying, a warm airflow is generated in the corresponding drying unit. During the drying phase, the airflow flows in the horizontal and/or vertical direction in the individual chambers.

Preferably, the individual chambers have perforated floors, which enable air to flow from chamber to chamber in the drying device. Consequently, in addition to the above-mentioned airflows in the individual chambers of the drying device, which has, for example, drying units arranged above one another, there is vertical airflow from chamber to chamber.

In a preferred design of the drying device according to the invention, the drying units can be loaded with workpieces independently of each other.

A first number of painted workpieces is inserted in a correspondingly first drying unit, such that the first drying unit can be loaded with workpieces. A second number of painted workpieces is inserted in a correspondingly second drying unit, such that the second drying unit can also be loaded with workpieces, independently of the first drying unit.

In a further preferred design of the drying device according to the invention, the drying units have at least one opening, which is set up as an inlet and/or outlet for the workpieces to be dried.

The openings are closable openings such as, for example, flaps. However, sluices may be provided for closing the openings. The openings must be closable, so that the same constant temperature prevails in the drying units inside the drying device. A supply of air from outside the drying device can thus be prevented.

In a further preferred design of the drying device according to the invention, the drying device has at least one distributing device, wherein the workpieces can be inserted in and/or removed from the drying units by means of the distributing device.

The distributing device is designed, on the one hand, to load the drying units of the drying device with painted workpieces. On the other hand, the distributing device is designed to convey the dried workpieces (after completion of drying) back out of the corresponding drying unit.

In a further preferred design of the drying device according to the invention, the distributing device has a lifting device and a conveying device.

The lifting device is mounted in a displaceable manner on the distributing device. Displacement of the lifting device is effected vertically along the distributing device, and corresponds to an upward and downward movement of the lifting device. The lifting device additionally has a conveying device. The lifting device lifts the workpieces to the height at which there is a free drying unit to receive the workpieces in the drying device. The workpieces can then be inserted in and/or removed from the drying units by means of the distributing device.

In a further preferred design of the drying device according to the invention, the dimensions of the drying unit are selected to receive a workpiece carrier system.

The number of workpieces can be inserted, on a workpiece carrier system, in the drying unit. The workpiece carrier system is, for example, a transport unit for receiving the multiplicity of workpieces, or for receiving only one workpiece. The workpiece carrier system may also be, for example, a band conveyor, mesh conveyor, steel conveyor, belt conveyor or roller conveyor. The conveying device, as described above, may also be realized as a workpiece carrier system.

In a further preferred design of the drying device according to the invention, the distributing device has a lifting device and/or a shift device.

Whereas, the lifting device, as described above, can only execute a vertical upward and downward movement along the distributing device, the shift device executes a horizontal movement of the distributing device.

In a further preferred design of the drying device according to the invention, the drying units are arranged vertically above one another and/or vertically next to one another.

It is thus possible for a multiplicity of drying units, which are next to one another and above one another, to be loaded with workpieces.

In a further preferred design of the drying device according to the invention, the drying device has a control unit for controlling the distributing device. The control unit is set to insert the workpieces in a free drying unit in the drying device and to remove the workpieces from the drying device.

Furthermore, the control unit has a timer, a memory and a processor, for determining the retention time of the workpieces in respectively one of the drying units.

The timer is used to measure the period of time over which the workpiece to be dried has already been drying in the drying device. The memory stores all information, for example which paint is to be dried on which workpiece, how long the workpieces have already been drying in the drying unit, and how much longer the drying operation will take in which of the drying units. The processor calculates when the workpieces can be removed, fully dried, from the device. The control unit detects whether there is a free drying unit available in the drying device. If a free drying unit is found, the workpiece is inserted in the free drying unit by means of the distributing device, controlled by the control device. As mentioned above, the control unit determines how long a workpiece has to dry at a constant temperature. Following completion of the drying operation, the dried workpiece is removed from the drying unit by means of the controlled distributing device.

In a further embodiment example of the present invention, further drying devices are provided, which can be accessed by means of a distributing device and a shift device.

By means of the shift device, the distributing device, together with the lifting device and the conveying device, can be displaced horizontally. Further drying devices, arranged horizontally next to one another, can be accessed, which drying devices, for example, all have the same temperature T1 in the drying units, as previously described.

Also provided, however, are drying devices that, unlike the drying devices described above, have a different temperature, T2, for drying the workpieces, wherein here, likewise, the temperature T2 is constant in the drying units.

For the purpose of achieving the object, the present invention proposes a method for drying, in particular for drying painted workpieces, comprising the following steps: receiving a first number of painted workpieces in a drying unit of a drying device, drying the first number of painted workpieces in the first drying unit at a constant temperature T, receiving at least one second number of painted workpieces in a further drying unit of the drying device, drying the at least second number of painted workpieces in the further drying unit at a constant temperature T, removing the first number of painted workpieces from the respective drying unit after a drying time t1, and removing the second number of painted workpieces from the second drying unit after a drying time t2.

In the case of a constant temperature T in the drying device, the first and the second number of workpieces can be dried independently of each other in respect of time. Accordingly, the first number of workpieces can be removed from the drying device, for example, after a time t1, and the second number of workpieces can be removed after a time t2. Moreover, a further number of workpieces t3-ti can be dried in the drying device, independently of each other in respect of time, at a constant temperature T.

A further preferred design of the method according to the invention for drying provides drying of painted workpieces in at least one second drying device at a constant temperature T2.

In the case of a constant temperature T2 in the second drying device, the first and the second number of workpieces can be dried independently of each other in respect of time. Accordingly, the first number of workpieces can be removed from the second drying device, for example, after a time t1, and the second number of workpieces can be removed after a time t2. Moreover, a further number of workpieces t3-ti can be dried in the second drying device, independently of each other in respect of time, at a constant temperature T.

### BRIEF DESCRIPTION OF THE FIGURES

FIG. 1 shows a first schematic view of the drying device according to the invention, wherein a first number of painted workpieces is located on a conveying device.

FIG. 2 shows a second schematic view of the drying device according to the invention, wherein the first number of painted workpieces is located on a lifting device.

FIG. 3 shows a third schematic view of the drying device according to the invention, wherein the first number of painted workpieces is located in a drying unit.

FIG. 4 shows a fourth schematic view of the drying device according to the invention, wherein a second number of painted workpieces is being removed from the drying unit.

FIG. 5 shows a plan view of the drying device according to the invention from FIGS. 1-4.

FIG. 6 shows an alternative embodiment of FIG. 5.

FIG. 7 shows an alternative embodiment, as compared with FIGS. 1-6.

FIG. 8 shows a plan view of the drying device according to the invention from FIG. 7.

### DESCRIPTION OF PREFERRED EMBODIMENTS

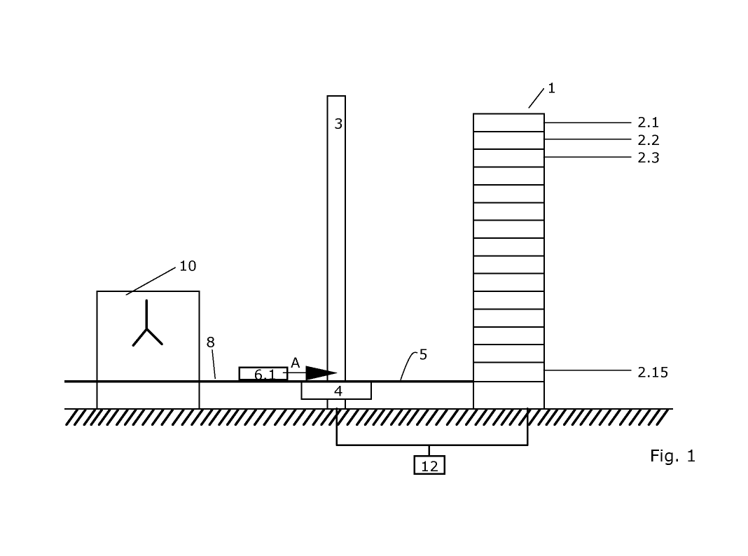

FIG. 1 shows a conveying device 8, which extends from the painting device 10 to a distributing device 3.

Mounted on the distributing device 3 there is a lifting device 4, which can be displaced vertically upwards, along the distributing device 3. The lifting device 4 has a conveying device 5. The conveying device 5 is provided on the lifting device 4.

The end of the conveying device 5 that faces away from the lifting device 4 is connected to a drying device 1.

The drying device 1 according to the invention is composed of a multiplicity of drying units 2.1 to 2.15 arranged above one another. For reasons of clarity, not all drying units are denoted individually.

The drying device 1 additionally has a control unit 12. The distributing device 3 and the drying device 1 can be controlled by the control unit. The painted workpieces 6.1 can be inserted in a free drying unit 2 of the drying device 1, and the dried workpieces 6.1 can be removed from the drying device 1, by means of the control unit 12.

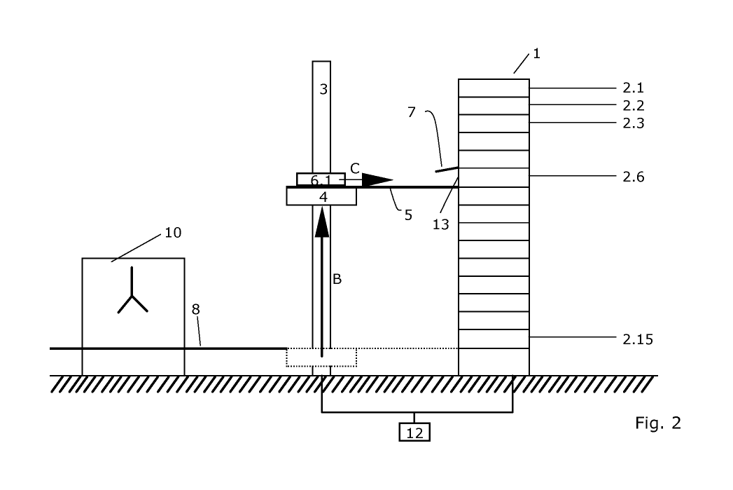

A number of painted workpieces 6.1, which have left the painting device 10, are located on the conveying device 8, on the way to the distributing device 3 (arrow A). The workpieces are then placed on the lifting device 4 of the distributing device 3, in order to be conveyed vertically upwards along the distributing device (arrow B) as represented in FIG. 2. The lifting device 4 conveys the workpieces up to a height at which there is a free drying unit 2.6 available to receive the workpieces 6.1.

FIG. 2 shows the vertical displacement of the lifting device 4 along the distributing device 3 (arrow B). The original position of the lifting device 4 and of the conveying device from FIG. 1 is represented by a broken line.

Each drying unit 2.1 to 2.15 has an opening 7, which is provided with a flap, in order to prevent the supply of air from outside the drying device 1. The opening 7 is located on the side of the drying unit from which the workpieces are inserted and removed. For reasons of clarity, only one opening 7 is represented.

The workpieces to be dried 6.1 are located on the conveying device 5, on the way to the drying device 1 (arrow C).

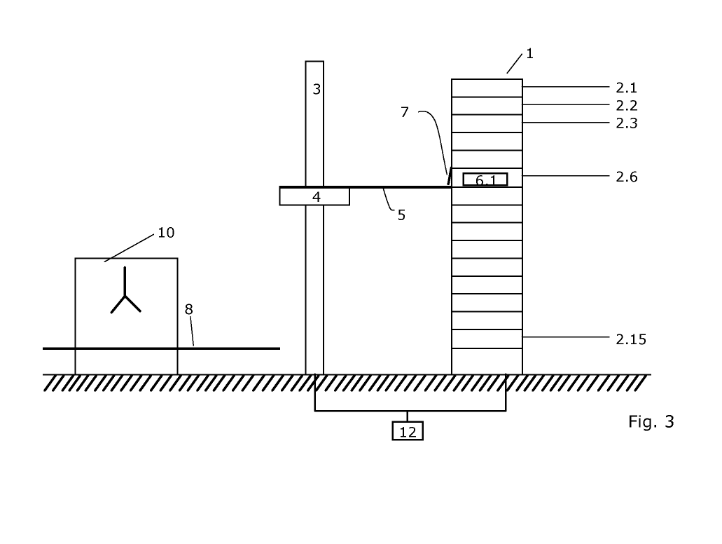

As represented in FIG. 3, the flap 7 has been lifted up. The drying unit 2.6 is prepared for the insertion of the workpieces 6.1. The conveying device 5 conveys the workpieces 6.1 into the free drying unit 2.6. After the workpieces 6.1 have been inserted, the flap 7 is closed again. The drying operation is performed at a constant temperature in the drying device 1 as a whole, in the drying unit 2.6.

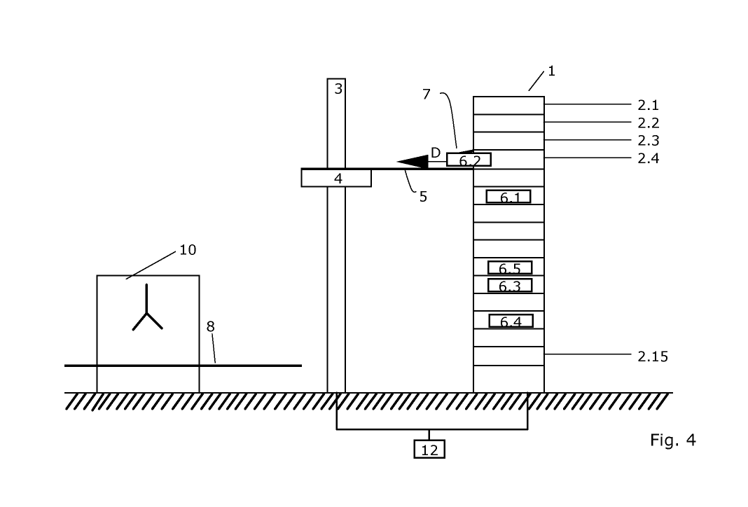

FIG. 4 shows further workpieces 6.2, etc., which have likewise been inserted in further drying units 2.4, etc. in the drying device 1, for the drying operation at constant temperature. In FIG. 4, the drying time for the workpieces 6.2 has ended, such that the workpieces 6.2 can be removed from the drying unit 2.4. Since the drying of the workpieces 6.2 is effected independently of the drying of the workpieces 6.1, etc. in respect of time, the drying of the workpieces 6.1, etc. is not complete in this case. The flap 7 is opened in order to remove the dried workpieces 6.2 from the drying unit 2.4. The workpieces 6.2 are removed in the direction of the arrow D. The conveying device 5 removes the workpieces 6.2 from the drying unit 2.4 in the direction of the distributing device 3.

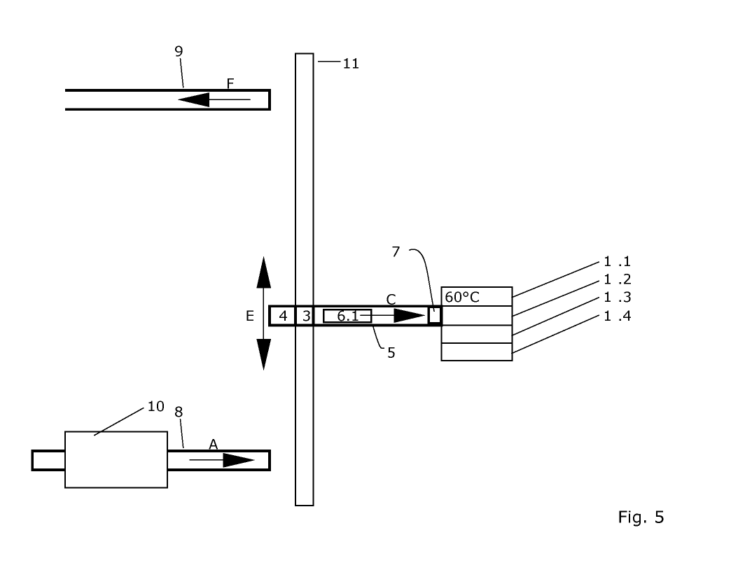

As represented in the plan view in FIG. 5, the workpieces 6.2 can be transported away by means of a conveying device 9. For this purpose, the lifting device 4 must first be lowered, with the workpieces 6.2, to the level of the conveying device 9.

Provided in FIG. 5 are further drying devices 1.1 to 1.4, arranged horizontally next to one another, which all have the same temperature in the drying units (for example, 60° C.)

FIG. 5 additionally shows a shift device 11. By means of the shift device 11, the distributing device 3, together with the lifting device 4 and the conveying device 5, can be displaced horizontally (arrow E). Painted workpieces can be inserted in one of the free drying units of the drying devices 1.1 to 1.4. After completion of drying, the workpieces can be transported away via the conveying device 9.

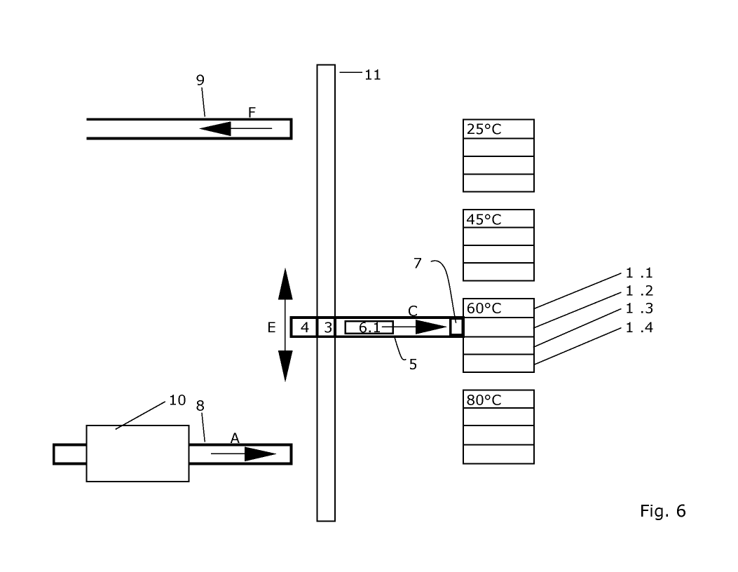

Like FIG. 5, FIG. 6 shows a shift device 11. By means of the shift device 11, the distributing device 3, together with the lifting device 4 and the conveying device 5, can be displaced horizontally (arrow E). In FIG. 6, further drying devices, arranged horizontally next to one another, are provided in addition to the drying devices 1.1 to 1.4. For reasons of clarity, not all drying devices are denoted individually. The further drying devices have, in the respective drying units, temperatures that differ from those of the drying devices 1.1 to 1.4 (for example, 25° C., 45° C., 60° C. and 80° C.). For reasons of clarity, not all drying devices are denoted individually.

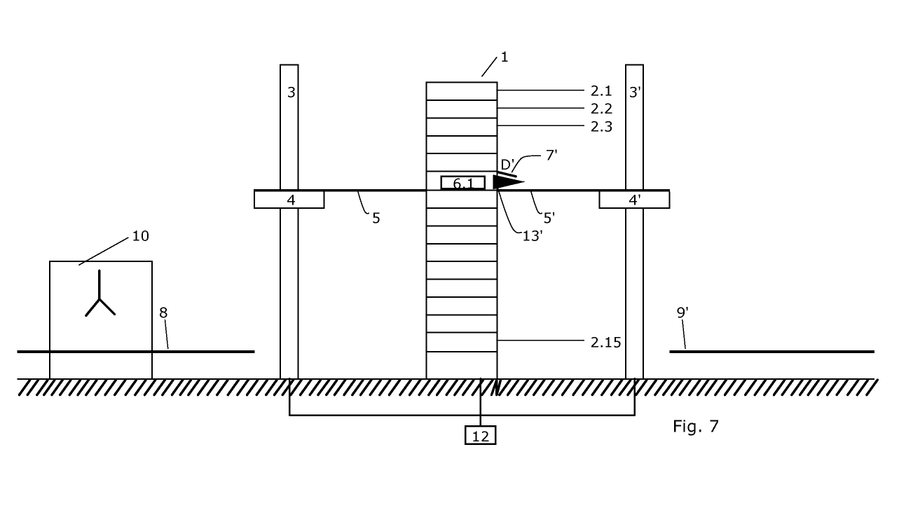

FIG. 7 shows an alternative embodiment, as compared with FIGS. 1 to 6. Unlike FIG. 4, after the drying time for the materials has been completed, the flap 7′, not the flap 7, is opened, in order to remove the dried workpieces from the drying unit. The flap 7′ is arranged on the side opposite the flap 7.

In FIG. 7, the workpieces 6.1 are removed in the direction of the arrow D. The conveying device 5′ transports the workpieces 6.1, in the direction of the distributing device 3′, on to the lifting device 4′. The lifting device 4 is lowered to the level of the conveying device 9′. The workpieces 6.1 can be transported away via the conveying device 9′.

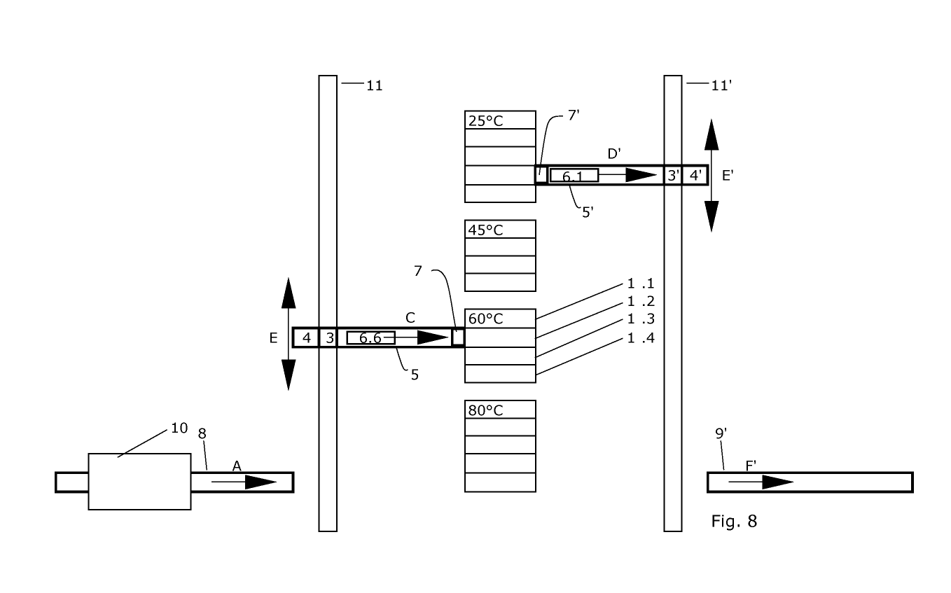

Unlike FIG. 6, FIG. 8 shows a further shift device 11′. By means of the shift device 11′, the distributing device 3′, together with the lifting device 4′ and the conveying device 5′, can be displaced horizontally (arrow E′). It is thereby possible to remove dried workpieces from the drying device 1 and to deliver them to the conveying device 9′ (arrow F′). As in FIG. 6, further drying devices, arranged horizontally next to one another, are provided in addition to the drying devices 1.1 to 1.4. For reasons of clarity, not all drying devices are denoted individually. The further drying devices have, in the respective drying units, temperatures that differ from those of the drying devices 1.1 to 1.4 (for example, 25° C., 45° C., 60° C. and 80° C.). For reasons of clarity, not all drying devices are denoted individually.

The invention provides a device and a method for drying, in particular for drying painted workpieces, in which flexible drying times can be achieved and in which the workpieces can rest during the retention time in the drying device.

### LIST OF REFERENCES

1 drying device
2 drying unit
3 distributing device
4 lifting device
5 conveying device
6 workpiece
7 closure
8 conveying device
9 conveying device
10 painting device
11 shift device
12 control device
13 opening

1. A drying device, in particular for drying painted workpieces, comprising
at least two drying units, wherein the individual drying unit is set up to receive a number of painted workpieces, and
heating means, which are set up to generate a constant temperature in the drying device and in each of the drying units.

2. The drying device according to claim 1, wherein the drying units can be loaded with workpieces independently of each other.

3. The drying device according to claim 1, wherein the drying units have at least one opening, which is set up as an inlet and/or outlet for the workpieces to be dried.

4. The drying device according to claim 1, additionally having at least one distributing device, wherein the workpieces can be inserted in and/or removed from the drying units by means of the distributing device.

5. The drying device according to claim 4, wherein the distributing device has a lifting device and a conveying device.

6. The drying device according to claim 1, wherein the dimensions of the drying unit are selected to receive a workpiece carrier system.

7. The drying device according to claim 4, wherein the distributing device ) has a lifting device and/or a shift device.

8. The drying device according to claim 1, wherein the drying units are arranged vertically above one another and/or vertically next to one another.

9. The drying device according to claim 4, additionally having a control unit for controlling the distributing device,
for inserting the workpieces in a free drying unit in the drying device, and
for removing the workpieces from the drying device.

10. The drying device according to claim 9, wherein the control unit has a timer, a memory and a processor, for determining the retention time of the workpieces in respectively one of the drying units.

11. The drying device according to claim 1, additionally having further drying devices, which can be accessed by means of a distributing device and a shift device.

12. A method for drying, in particular for drying painted workpieces (6), comprising the following steps:
receiving a first number of painted workpieces in a drying unit of a drying device,
drying the first number of painted workpieces in the first drying unit at a constant temperature T,
receiving at least one second number of painted workpieces in a further drying unit of the drying device,
drying the at least second number of painted workpieces in the further drying unit at a constant temperature T,
removing the first number of painted workpieces from the respective drying unit after a drying time t1,
removing the second number of painted workpieces from the second drying unit after a drying time t2.

13. The method for drying according to claim 12, additionally comprising the following steps:
drying of painted workpieces in at least one second drying device at a constant temperature T2.
